(19) United States
(12) Patent Application Publication
(10) Pub. No.: US 2011/0300893 A1
(43) Pub. Date: Dec. 8, 2011

(54) WIRELESS TERMINAL DEVICE, WIRELESS COMMUNICATION SYSTEM, AND WIRELESS COMMUNICATION CONTROL METHOD

(75) Inventors: Yasuaki Inatomi, Kanagawa (JP); Yukio Shikatani, Kanagawa (JP)

(73) Assignee: Panasonic Corporation, OSAKA (JP)

(21) Appl. No.: 13/202,750

(22) PCT Filed: Dec. 3, 2010
(86) PCT No.: PCT/JP2010/007062

§ 371 Date: Aug. 22, 2011

(30) Foreign Application Priority Data
Dec. 24, 2009 (JP) 2009-293252

(51) Int. Cl. H04W 4/00

(52) U.S. Cl. 455/517

(57) ABSTRACT

A radio terminal apparatus is provided that enables a delay in information reception to be more dependably prevented while suppressing power consumption. A radio terminal apparatus (400) has an application section (403) that acquires by means of radio communication, and uses, service data that includes a plurality of items of information that should be acquired at different predetermined intervals, a radio communication section (402), a within-service-range determination section (405) that determines, by means of radio communication, which of the plurality of items of information is possible to be acquired, based on service data acquired by means of radio communication, and an activation control section (401) that, when it is possible to acquire at least one of the plurality of items of information by means of radio communication, controls activation/stopping of the radio communication section (402) so as to perform radio communication at a predetermined interval corresponding to that information. When it is impossible to acquire any of the plurality of items of information by means of radio communication, the activation control section (401) controls activation/stopping of the radio communication section (402) so as to perform radio communication at the shortest interval among a plurality of predetermined intervals.

### TECHNICAL FIELD

The present invention relates to a radio communication terminal that acquires and uses a plurality of items of information that should be acquired at different predetermined intervals, a radio communication system that includes this radio communication terminal, and a radio communication control method used by this radio communication terminal.

### BACKGROUND ART

Portable radio terminal apparatuses capable of acquiring information by means of radio communication from radio base stations positioned around town, for example, (hereinafter referred to simply as radio terminal apparatuses) are attracting attention. A radio terminal apparatus can easily perform acquisition of information relating to the user's current location, such as traffic information or sightseeing information relating to the environs of a radio base station. An active tag is one example of the use of a radio terminal apparatus. An active tag is a type of wireless tag (RFID: radio frequency identification) that is capable of communication over several tens of meters through the incorporation of a battery. In this case, a radio base station performs broadcast transmission, repeated at short intervals, of information directed toward its own communication area.

Various kinds of information transmitted from a radio base station include information that should be acquired virtually in real time. Such information includes, for example, highly urgent information reporting the approach of a vehicle. A radio terminal apparatus can secure real-time information reception capability by keeping a radio communication circuit that performs radio communication in an activated state.

However, keeping a radio communication circuit of a radio terminal apparatus in an activated state is undesirable from the standpoint of power consumption. Thus, current practice is for a permitted value of a delay time until information is acquired after a radio terminal apparatus enters the communication area of a radio base station to be made an interval in which information should be acquired (hereinafter referred to as “interval for acquisition”), and for a radio communication circuit to be activated intermittently at such intervals. By this means, a radio terminal apparatus can implement reception in accordance with required information while suppressing power consumption.

However, an interval for acquisition of information provided by a radio base station may differ according to the installation location of the radio base station, the time of day, and so forth. For example, the interval for acquisition differs for information that needs to be acquired in a short interval of a second or so, such as vehicle approach information (information with a high real-time notification requirement), and information for which acquisition at intervals of several tens of seconds, such as sightseeing information (information with a low real-time notification requirement). In order for a radio terminal apparatus to receive all such information for which the real-time notification requirement differs, it is necessary for the radio communication circuit of the radio terminal apparatus to be activated at intervals in line with a high real-time notification requirement (a short permitted delay time value). However, in such a case, a state occurs in which the radio communication circuit continues to be activated at short intervals of one second even in the communication area of a radio base station by which only information with a low real-time notification requirement, such as sightseeing information, is transmitted. Using a radio communication circuit activation interval that is shorter than necessary is undesirable from a power-saving standpoint.

Thus, a radio terminal apparatus has heretofore been proposed that changes the radio communication circuit activation interval according to the information type of information that can be received from a radio base station (see Patent Literature 1, for example). Here, an information type means a category of information corresponding to an interval for acquisition.

FIG. 1 is a schematic diagram showing an overview of the operation of a radio terminal apparatus described in Patent Literature 1 (hereinafter referred to as “conventional apparatus”). As shown in FIG. 1, conventional apparatus 10 holds internally correspondence table 11 in which an information type of information subject to acquisition by conventional apparatus 10 is associated with a timer value for that information type. Here, a timer value is an interval for acquisition of information of that information type. In this example, a 2-second timer value is associated with information type 1, and a 1-second timer value is associated with information type 2. Also, radio base station 20 transmits only information of information type 1 at time t1, and transmits information of information type 1 and information type 2 at time t3.

When there is only one information type of information that can be received from the radio base station, conventional apparatus 10 references correspondence table 11, sets the corresponding timer value as an activation interval, and performs reception with the radio communication circuit activated at that interval. When there are a plurality of information types of information that can be received from the radio base station, conventional apparatus 10 references correspondence table 11, sets the timer value with the smallest value from among the corresponding timer values as an activation interval, and performs reception with the radio communication circuit activated at that interval. That is to say, here, conventional apparatus 10 makes the time t1 activation interval 2 seconds, and makes the time t3 activation interval 1 second.

Thus, conventional apparatus 10 can keep the radio communication circuit activation interval to a necessary minimum, and can suppress unnecessary power consumption.

### CITATION LIST

### Patent Literature

### PTL 1

Japanese Patent Application Laid-Open No. 2004-128949

### SUMMARY OF INVENTION

### Technical Problem

However, when conventional apparatus 10 travels between a plurality of radio base stations with mutually separated communication areas, there is a problem of an actual delay time exceeding a permitted value.

FIG. 2 is a schematic diagram for explaining the above problem with conventional apparatus 10. As shown in FIG. 2, a case is assumed in which conventional apparatus 10 travels from first communication area 21-1 of first radio base station 20-1 to second communication area 21-2 of second radio base station 20-2. Here, first radio base station 20-1 transmits only information of information type 1, and second radio base station 20-2 transmits only information of information type 2. It is assumed that conventional apparatus 10 is first located in first communication area 21-1 until just before time t3. It is then assumed that, due to user traveling or the like, conventional apparatus 10 travels out of first communication area 21-1 just before time t3, and enters second communication area 21-2 just after time t6.

In such a case, conventional apparatus 10 enters second communication area 21-2 and performs initial reception at time t7, at which time the first communication area 21-1 activation interval of 2 seconds has elapsed since time t6. That is to say, although the radio communication circuit must originally be activated every second—that is, at time t62 after the elapse of 1 second from time t61 at which second communication area 21-2 is entered at the latest—the radio communication circuit is activated later than this, at time t7. Delay time D (from time t62 to time t7) of the actual reception time with respect to the original reception time is a maximum of 1 second. Thus, there is a possibility of conventional apparatus 10 greatly exceeding the permitted value, and of information reception being delayed.

It is therefore an object of the present invention to provide a radio terminal apparatus, radio communication system, and radio communication control method that enable a delay in information reception to be more dependably prevented while suppressing power consumption.

### Solution to Problem

A radio terminal apparatus of the present invention performs radio communication with a radio base station, and has: an application section that acquires by means of the radio communication, and uses, service data that includes a plurality of items of information that should be acquired at different predetermined intervals; a radio communication section that performs the radio communication; an in-service-area determination section that determines, by means of the radio communication, which of the plurality of items of information is possible to be acquired, based on service data acquired by means of the radio communication; and an activation control section that, when it is possible to acquire at least one of the plurality of items of information by means of the radio communication, controls activation/stopping of the radio communication section so as to perform the radio communication at the predetermined interval corresponding to that information; wherein the activation control section, when it is impossible to acquire any of the plurality of items of information by means of the radio communication, controls activation/stopping of the radio communication section so as to perform the radio communication at the shortest interval among the plurality of predetermined intervals.

A radio communication system of the present invention has: a plurality of radio base stations that transmit respectively, by means of radio communication, service data that includes at least one of a plurality of items of information that should be acquired at different predetermined intervals, and that have mutually separated communication areas; and a radio terminal apparatus that can travel between communication areas of the plurality of radio base stations, and performs radio communication with the radio base station; wherein the radio base station transmits, by means of the service data, information relating to a minimum traveling time when traveling from a communication area of that radio base station to a communication area of another neighboring radio base station; and the radio terminal apparatus has: an application section that acquires by means of the radio communication, and uses, service data that includes the plurality of items of information; a radio communication section that performs the radio communication; an in-service-area determination section that determines, by means of the radio communication, which of the plurality of items of information is possible to be acquired, based on service data acquired by means of the radio communication, and acquires the minimum traveling time; an activation control section that, when it is possible to acquire at least one of the plurality of items of information by means of the radio communication, controls activation/stopping of the radio communication section so as to perform the radio communication at the predetermined interval corresponding to that information; and an out-of-area activation interval selection section that, when a time when it is impossible to acquire any of the plurality of items of information by means of the radio communication reaches a predetermined length of time based on the minimum traveling time, causes the activation control section to switch to control of the shortest interval among the plurality of predetermined intervals.

A radio communication control method of the present invention is a radio communication control method in a radio terminal apparatus provided with a radio communication section that performs radio communication with a radio base station and an application section that acquires by means of the radio communication, and uses, service data that includes a plurality of items of information that should be acquired at different predetermined intervals, and has: a step of determining, by means of the radio communication, which of the plurality of items of information is possible to be acquired, based on service data acquired by means of the radio communication; a step of, when a time when it is impossible to acquire any of the plurality of items of information by means of the radio communication reaches a predetermined length of time, switching control of activation/stopping of the radio communication section so as to perform the radio communication at the shortest interval among the plurality of predetermined intervals; and a step of, when it is possible to acquire at least one of the plurality of items of information by means of the radio communication, switching control of activation/stopping of the radio communication section so as to perform the radio communication at the predetermined interval corresponding to that information.

### Advantageous Effects of Invention

The present invention enables a delay in information reception to be more dependably prevented while suppressing power consumption.

### BRIEF DESCRIPTION OF DRAWINGS

FIG. 1 is a schematic diagram showing an overview of the operation of a conventional apparatus;

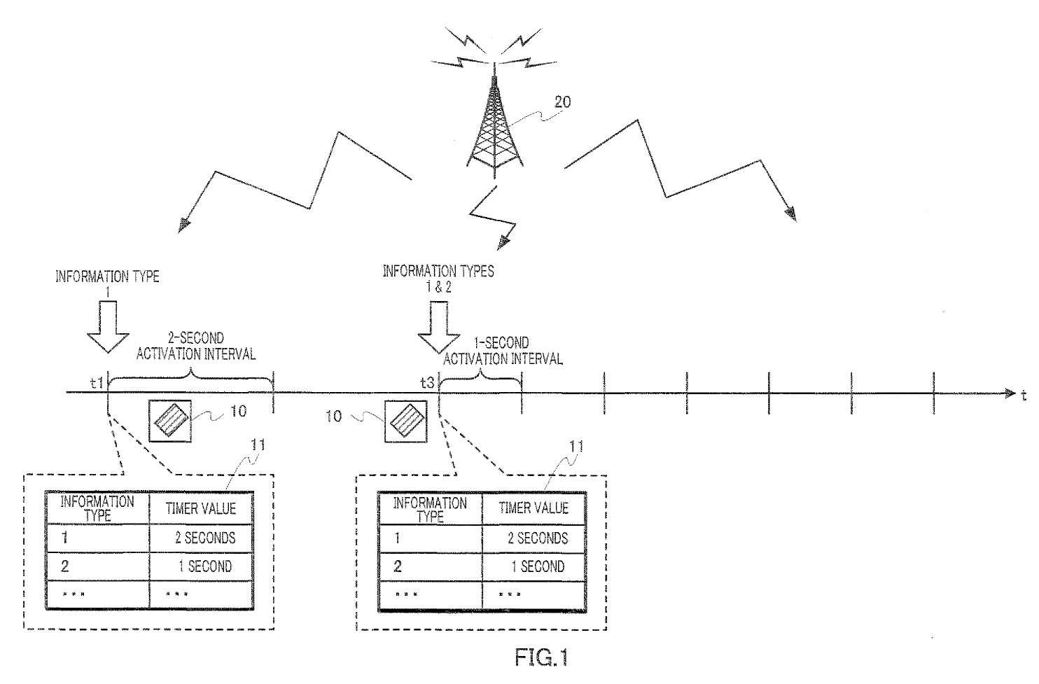

FIG. 2 is a schematic diagram for explaining a problem with a conventional apparatus;

FIG. 3 is a system configuration diagram showing the configuration of a radio communication system according to Embodiment 1 of the present invention;

FIG. 4 is a schematic diagram showing the nature of service data transmission by a radio base station in Embodiment 1;

FIG. 5 is a drawing showing an example of the configuration of service data in Embodiment 1;

FIG. 6 is a drawing for explaining an example of information types in Embodiment 1;

FIG. 7 is a schematic diagram showing an example of a service data transmission method in Embodiment 1;

FIG. 8 is a block diagram showing the configuration of a radio terminal apparatus according to Embodiment 1;

FIG. 9 is a drawing showing an example of the configuration of a correspondence table in Embodiment 1;

FIG. 10 is a flowchart showing an example of the overall operation of a radio terminal apparatus according to Embodiment 1;

FIG. 11 is a flowchart showing the operation of an activation control section in Embodiment 1;

FIG. 12 is a flowchart showing the operation of a radio communication section in Embodiment 1;

FIG. 13 is a flowchart showing the operation of an in-service-area determination section in Embodiment 1;

FIG. 14 is a flowchart showing the operation of an in-area activation interval selection section in Embodiment 1;

FIG. 15 is a flowchart showing the operation of an out-of-area determination section in Embodiment 1;

FIG. 16 is a flowchart showing the operation of an out-of-area time counting section in Embodiment 1;

FIG. 17 is a flowchart showing the operation of an out-of-area activation interval selection section in Embodiment 1;

FIG. 18 is a schematic diagram for explaining the effect of a radio terminal apparatus according to Embodiment 1;

FIG. 19 is a block diagram showing the configuration of a radio terminal apparatus according to Embodiment 2 of the present invention; and

FIG. 20 is a flowchart showing the operation of an maximum out-of-area time value calculation section in Embodiment 2.

### DESCRIPTION OF EMBODIMENTS

Now, embodiments of the present invention will be described in detail with reference to the accompanying drawings.

### Embodiment 1

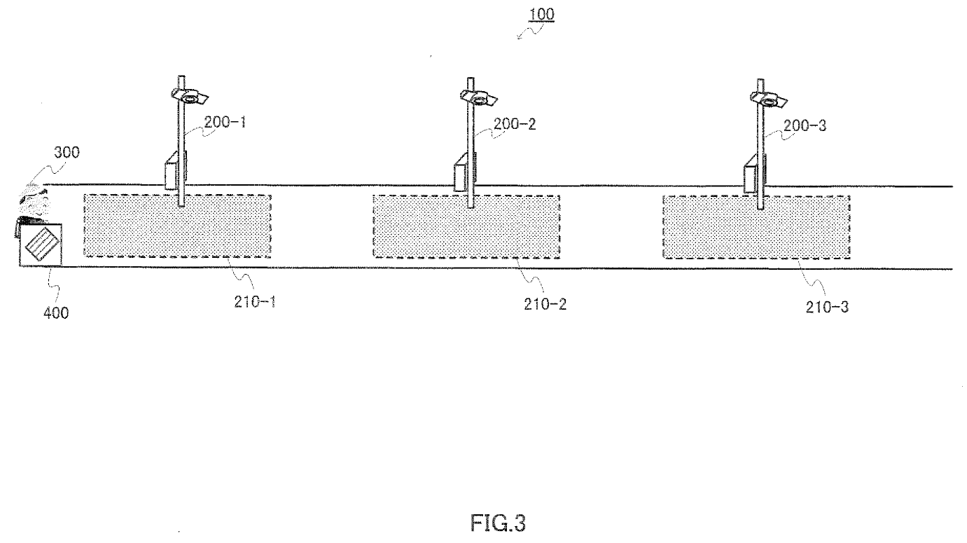

FIG. 3 is a system configuration diagram showing the configuration of a radio communication system according to Embodiment 1 of the present invention. In this embodiment, a case is described by way of example in which the present invention is applied to a radio communication system in which various kinds of information are provided to a radio terminal apparatus carried by a pedestrian from a plurality of radio base stations positioned around town.

As shown in FIG. 3, radio communication system 100 has first through third radio base stations 200-1 through 200-3 around town, and radio terminal apparatus 400 according to the present invention carried by user 300 walking around town.

First through third communication areas 210-1 through 210-3 that are the communication areas of first through third radio base stations 200-1 through 200-3 are separated from each other. That is to say, first through third radio base stations 200-1 through 200-3 are installed intermittently at distances at which first through third communication areas 210-1 through 210-3 do not overlap. Radio terminal apparatus 400 travels, for example, through first through third communication areas 210-1 through 210-3, in that order, due to the traveling of user 300.

Each radio base station 200 transmits service data that includes various kinds of information toward its own communication area 210.

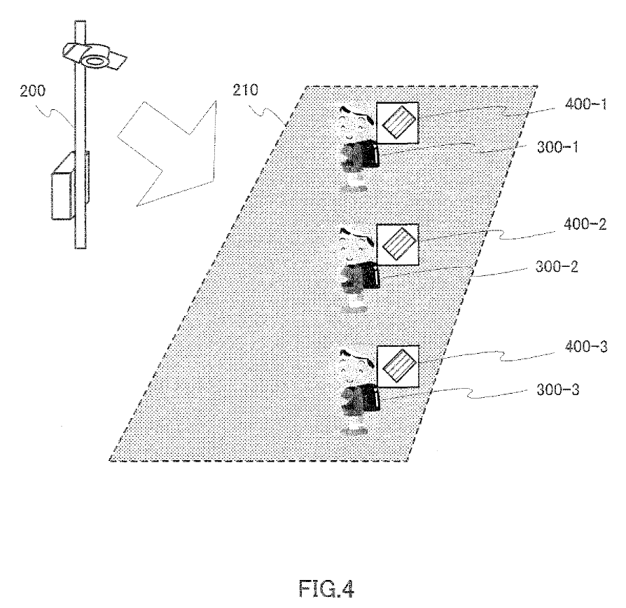

FIG. 4 is a schematic diagram showing the nature of service data transmission by radio base station 200.

As shown in FIG. 4, radio base station 200 performs broadcast transmission in predetermined cycles of service data that includes various kinds of information directed toward its own communication area. Here, a case is assumed in which first through third users 300-1 through 300-3 are located in the same communication area 210. It is also assumed that first through third users 300-1 through 300-3 are carrying first through third radio terminal apparatuses 400-1 through 400-3 respectively. In this case, first through third radio terminal apparatuses 400-1 through 400-3 receive the same service data.

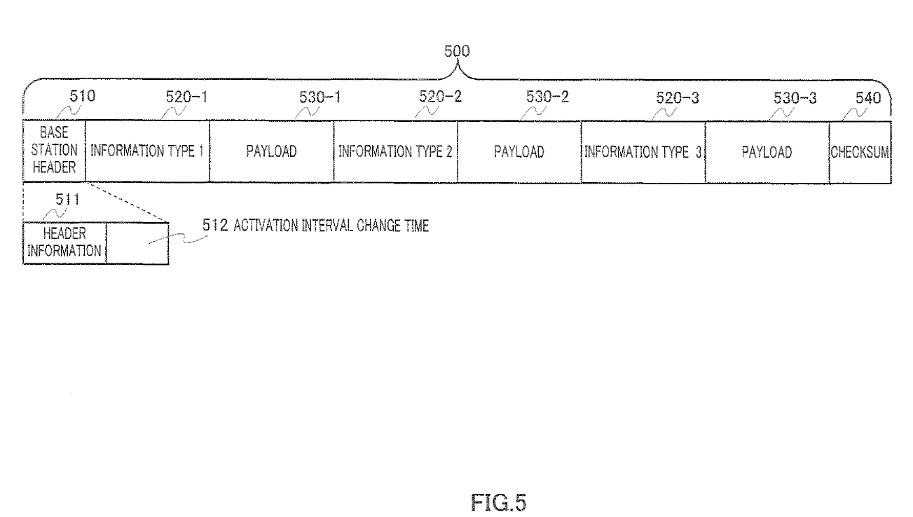

FIG. 5 is a drawing showing an example of the configuration of service data transmitted by radio base station 200.

As shown in FIG. 5, service data 500 includes base station header 510, at least one information type 520 plus payload 530 pair, and checksum 540. Base station header 510 includes header information 511 and activation interval change time 512. Activation interval change time 512 will be described later herein.

Payload 530 includes various kinds of information provided to radio terminal apparatus 400. Information type 520 corresponding to payload 530 contains a category of information corresponding to an interval for acquisition of information stored in that payload 530, as an information type.

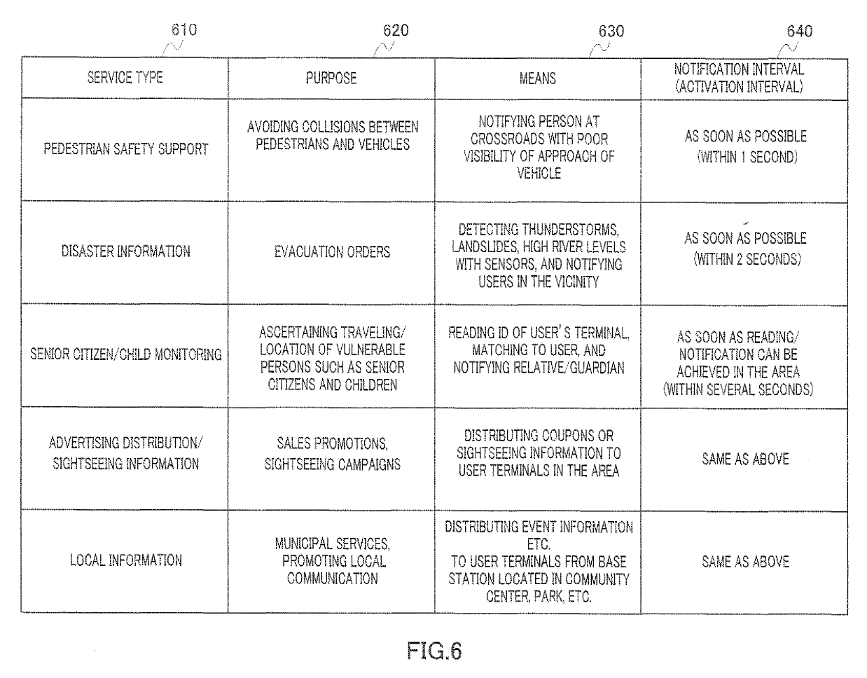

FIG. 6 is a drawing for explaining an example of information types used in radio communication system 100.

As shown in FIG. 6, in radio communication system 100, information belonging to various kinds of service type 610 is provided to radio terminal apparatus 400 user 300. Information provided by each service type 610 includes provision purpose 620, actual means of provision 630, and appropriate notification interval 640.

For example, it is desirable for radio terminal apparatus 400 to be notified of vehicle approach information provided by a pedestrian safety support service within 1 second after information transmission is started in corresponding communication area 210. Also, for example, it is desirable for radio terminal apparatus 400 to be notified of evacuation order information provided by a disaster information service within 2 seconds after information transmission is started in corresponding communication area 210.

In this embodiment, an information type is a category of information subject to acquisition by radio terminal apparatus 400, corresponding to a notification interval (that is, an interval for acquisition). That is to say, for the same information, a notification interval belongs to the same information type. Here, an information type to which information with a 2-second notification interval such as disaster information belongs is designated information type 1, and an information type to which information with a 1-second notification interval such as pedestrian safety support information belongs is designated information type 2. When radio terminal apparatus 400 activates its radio communication circuit intermittently, it is necessary for the radio communication circuit activation interval to be the same as, or shorter than, the required notification interval.

The information types of information included in service data transmitted from each radio base station 200 need not be the same in all radio base stations 200. This is because information types that should be provided to user 300 differ according to the place or region in which radio base station 200 is located. For example, in town, only information of information type 1 corresponding to a pedestrian safety support service is provided, whereas in a riverside area, only information of information type 2 corresponding to a disaster information service is provided. As shown in FIG. 5, service data 500 transmitted by radio base station 200 can be stored with information of a plurality of different information types multiplexed.

A change time is then stored in activation interval change time 512 of service data 500 shown in FIG. 5.

A change time is a time period until the current radio communication circuit activation interval is discarded (the activation interval is changed) after information can no longer be acquired, and is information given to radio terminal apparatus 400. A change time is, for example, a time period shorter than a minimum traveling time for traveling of user 300 from communication area 210 of transmitting radio base station 200 to another neighboring communication area 210. The other neighboring communication area 210 envisaged here is the nearest communication area 210. Also, user 300 envisaged here is a user with a comparatively fast walking speed, such as an adult.

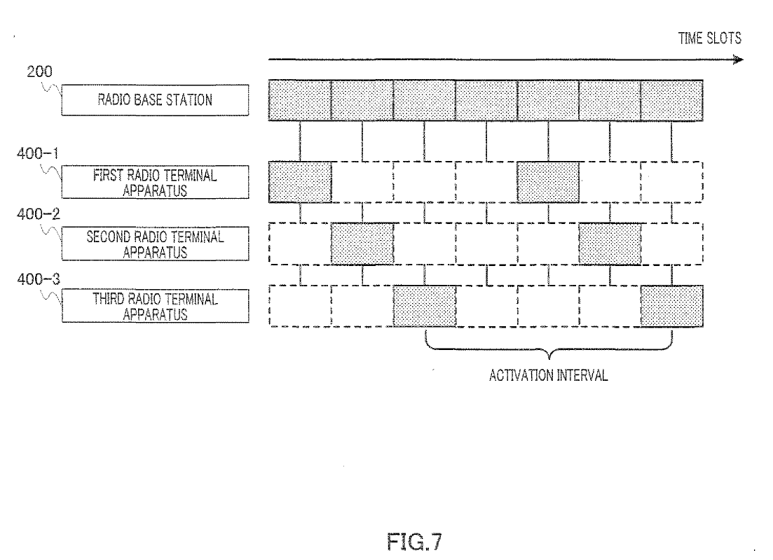

FIG. 7 is a schematic diagram showing an example of a transmission method for radio base station 200 service data 500.

As shown in FIG. 7, radio terminal apparatuses 400 perform reception processing of service data 500 transmitted by radio base station 200 by means of a TDMA system (time division multiple access system).

Each radio terminal apparatus 400 activates its timing control circuit every activation interval set for itself, and performs subsequent service data 500 reception processing using the activation-time time slot. Activation interval setting will be described later herein. Here, a case is illustrated in which first through third radio terminal apparatuses 400-1 through 400-3 are located in communication area 210 of radio base station 200, and each perform communication using a different time slot. By this means, first through third radio terminal apparatuses 400-1 through 400-3 can, for example, individually receive only service data addressed to themselves.

The configuration of radio terminal apparatus 400 will now be described.

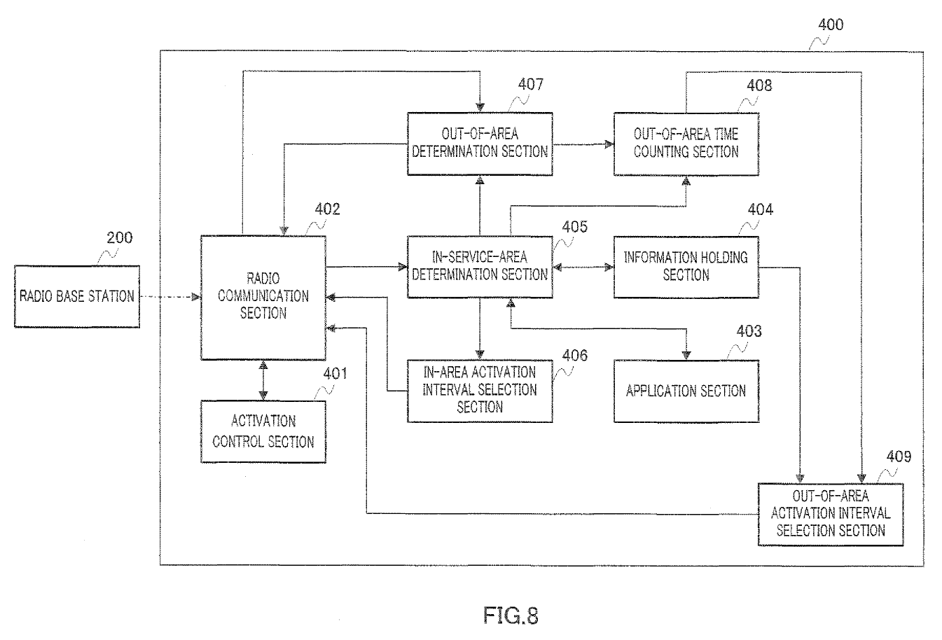

FIG. 8 is a block diagram showing the configuration of radio terminal apparatus 400.

In FIG. 8, radio terminal apparatus 400 has activation control section 401, radio communication section 402, application section 403, information holding section 404, in-service-area determination section 405, in-area activation interval selection section 406, out-of-area determination section 407, out-of-area time counting section 408, and out-of-area activation interval selection section 409.

Activation control section 401 is connected to radio communication section 402. Activation control section 401, for example, is always in an active state when radio terminal apparatus 400 power is on, and starts activation/stopping control of the radio communication circuit or the like of radio communication section 402 using an internal timer.

More specifically, activation control section 401 receives an activation interval notification directly from radio communication section 402, or from in-area activation interval selection section 406 and out-of-area activation interval selection section 409 described later herein via radio communication section 402. Then activation control section 401 gives radio communication section 402 a reception time notification and service data reception directive at the notified activation interval. The reception time is a length of time for which reception of service data from radio base station 200 is to be waited for continuously, and is set, for example, in activation control section 401 when radio terminal apparatus 400 is manufactured.

Radio communication section 402 is connected to activation control section 401, in-service-area determination section 405, out-of-area determination section 407, in-area activation interval selection section 406, and out-of-area activation interval selection section 409. Radio communication section 402 has a radio communication circuit, and while this radio communication circuit is active, performs communication with radio base station 200 by means of a radio wave, and performs reception of the above-described service data. Below, activation of radio communication section 402 is assumed to mean activation of the radio communication circuit.

More specifically, each time radio communication section 402 is notified of a reception time and directed to perform service data reception, radio communication section 402 performs reception processing of service data from radio base station 200 during the notified reception time. If radio communication section 402 does not receive service data, radio communication section 402 calls out-of-area determination section 407 and starts out-of-area determination section 407 operation. If radio communication section 402 receives service data, radio communication section 402 passes the received service data to in-service-area determination section 405, and starts in-service-area determination section 405 operation. As a result, on receiving an activation interval from in-area activation interval selection section 406 or out-of-area activation interval selection section 409, radio communication section 402 sets the received activation interval in activation control section 401. Also, radio communication section 402 passes service data received in reception processing (hereinafter referred to as “received service data”) to application section 403 vian in-service-area determination section 405.

Application section 403 extracts stored information from received service data received from in-service-area determination section 405, and performs various kinds of application operations.

Information holding section 404 is connected to in-service-area determination section 405 and out-of-area activation interval selection section 409. Information holding section 404 holds an information type of information used by application section 403 (hereinafter referred to as “information type subject to use”), and a timer value of an activation interval corresponding to that information type, in an associated fashion in a correspondence table. In response to acquisition requests from in-service-area determination section 405 and out-of-area activation interval selection section 409, information holding section 404 returns an information type, or a timer value corresponding to a specified information type, entered in the correspondence table.

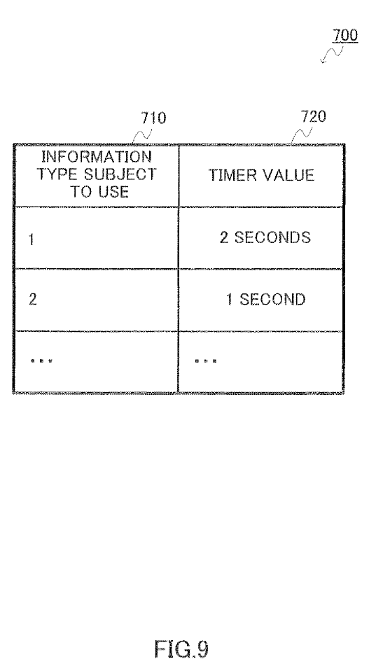

FIG. 9 is a drawing showing an example of the configuration of a correspondence table held by information holding section 404.

As shown in FIG. 9, correspondence table 700 contains information type subject to use 710 and timer value 720 corresponding to that information type subject to use 710. As explained above, timer value 720 is an interval at which radio communication section 402 is activated and service data reception processing is performed (an activation interval).

Correspondence table 700 may be set in information holding section 404 when radio terminal apparatus 400 is manufactured, or may be configured so as to be rewritten in coordination with activation and termination of each application by application section 403. Also, correspondence table 700 may have entered in it only an information type used by an application specified by user 300 among applications.

In-service-area determination section 405 in FIG. 8 is connected to radio communication section 402, in-area activation interval selection section 406, information holding section 404, out-of-area determination section 407, and out-of-area time counting section 408. In-service-area determination section 405 determines whether or not information of an information type subject to use is included in received service data received from radio base station 200.

If information of an information type subject to use is included in received service data, in-service-area determination section 405 passes the received service data to application section 403. Also, in-service-area determination section 405 calls, and starts operation of, in-area activation interval selection section 406, and passes all timer values corresponding to information types subject to use included in the received service data. Furthermore, in-service-area determination section 405 extracts a change time from the received service data, and passes the extracted change time to out-of-area time counting section 408.

On the other hand, if information of an information type subject to use is not included in received service data, in-service-area determination section 405 calls, and starts operation of, out-of-area determination section 407. In-service-area determination section 405 performs determination of whether or not information of an information type subject to use is included in received service data, and acquisition of a timer value corresponding to an information type subject to use, by referencing a correspondence table held by information holding section 404 (see FIG. 9).

In-area activation interval selection section 406 is connected to in-service-area determination section 405 and radio communication section 402. In-area activation interval selection section 406 selects the smallest timer value from among timer values received from in-service-area determination section 405, and notifies radio communication section 402 of the selected timer value as an activation interval.

Out-of-area determination section 407 is connected to radio communication section 402, in-service-area determination section 405, and out-of-area time counting section 408. If radio terminal apparatus 400 is located outside communication area 210, or if information of an information type subject to use is not included in received service data, out-of-area determination section 407 determines that radio terminal apparatus 400 is out of service area. Then, when out-of-area determination section 407 determines that radio terminal apparatus 400 is out of service area, out-of-area determination section 407 outputs an operation start directive to out-of-area time counting section 408.

Out-of-area time counting section 408 is connected to out-of-area determination section 407, in-service-area determination section 405, and out-of-area activation interval selection section 409. Out-of-area time counting section 408 sets a change time passed from in-service-area determination section 405 as an maximum out-of-area time value. Then out-of-area time counting section 408 receives an operation start directive from out-of-area determination section 407, and counts the time since the out-of-service-area state was entered, using an internal timer. Then, when the timer count reaches the set maximum out-of-area time value, out-of-area time counting section 408 calls out-of-area activation interval selection section 409.

Out-of-area activation interval selection section 409 is connected to out-of-area time counting section 408, information holding section 404, and radio communication section 402. Out-of-area activation interval selection section 409 receives a call from out-of-area time counting section 408, and selects a radio communication section 402 activation interval.

More specifically, out-of-area activation interval selection section 409 references a correspondence table held by information holding section 404 (see FIG. 9), and selects the smallest timer value among activation interval timer values corresponding to information types subject to use. Then out-of-area activation interval selection section 409 notifies radio communication section 402 of the selected timer value as an activation interval.

Although not shown, radio terminal apparatus 400 has, for example, a CPU (central processing unit), a storage medium such as flash memory that stores a control program, working memory such as RAM (random access memory), a radio communication circuit, and a plurality of timers that use the CPU clock. In this case, radio terminal apparatus 400 implements the functions of the above sections by execution of the control program by the CPU.

When determined to be within service area, radio terminal apparatus 400 having this kind of configuration can select the smallest notification interval among notification intervals from radio base station 200 with receivable information as an activation interval. By this means, radio terminal apparatus 400 can keep the frequency of radio communication circuit activation to a necessary minimum within service area.

On the other hand, when determined to have become out of service area, radio terminal apparatus 400 can select the smallest notification interval among notification intervals from radio base station 200 with information of a usable information type as an activation interval. By this means, even if information broadcast-transmitted in the next service area is information of an information type with a smaller notification interval, radio terminal apparatus 400 can activate its radio communication circuit at that communication interval just after entering the service area. That is to say, radio terminal apparatus 400 can activate its radio communication circuit without causing a delay in information reception.

The operation of radio terminal apparatus 400 will now be described. The overall operation of radio terminal apparatus 400 will first be described, followed by the operation of each apparatus section.

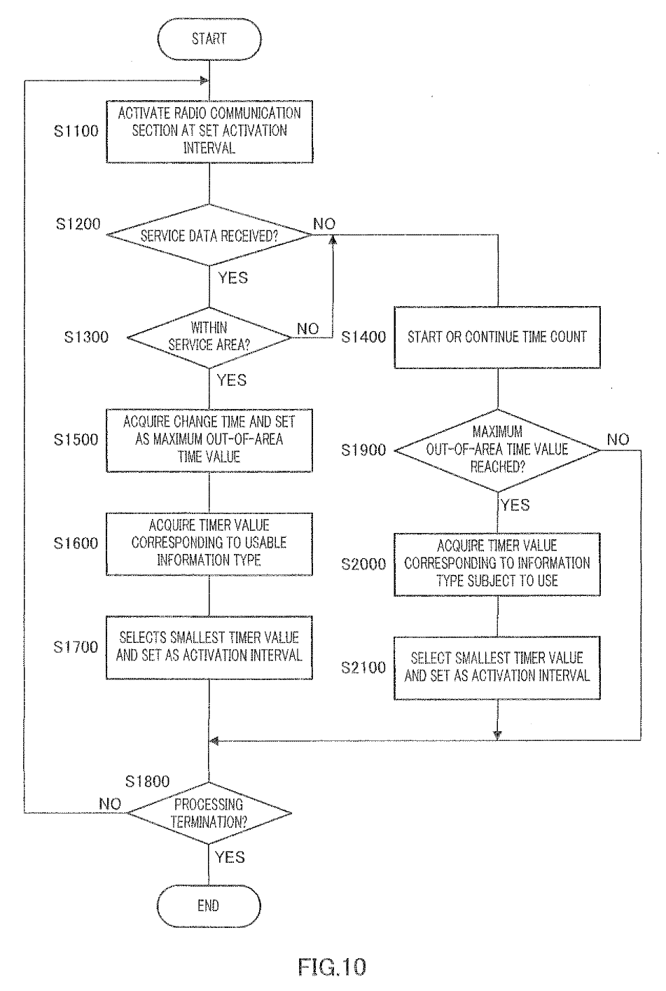

FIG. 10 is a flowchart showing an example of the overall operation of radio terminal apparatus 400. Radio terminal apparatus 400 starts operating when activation control section 401 is energized by insertion of a battery or the like.

First, in step S1100, activation control section 401 activates radio communication section 402 in accordance with a currently set activation interval, and notifies radio communication section 402 of a reception time. If an activation interval has not been set, such as just after radio terminal apparatus 400 is powered on, for example, activation control section 401 activates radio communication section 402 based on an activation interval held internally in advance as a default value.

Then, in step S1200, radio communication section 402 determines whether or not service data (see FIG. 5) broadcast-transmitted from radio base station 200 has been received during the notified reception time. If service data has been received (S1200: YES), radio communication section 402 passes the received service data to in-service-area determination section 405, and proceeds to step S1300. On the other hand, if service data has not been received (S1200: NO), radio communication section 402 calls out-of-area determination section 407, and proceeds to step S1400.

Then, in step S1300, in-service-area determination section 405 analyzes the received service data using a correspondence table held by information holding section 404 (see FIG. 9). Next, in-service-area determination section 405 determines whether or not radio terminal apparatus 400 is located within service area (whether radio terminal apparatus 400 is within service area or out of service area). That is to say, in-service-area determination section 405 determines whether or not information of an information type subject to use is included in the received service data.

If radio terminal apparatus 400 is within service area (S1300: YES), in-service-area determination section 405 passes the received service data to application section 403, and proceeds to step S1500. On the other hand, if radio terminal apparatus 400 is out of service area (S1300: NO), in-service-area determination section 405 calls out-of-area determination section 407, and proceeds to step S1400.

In step S1500, in-service-area determination section 405 acquires a change time from the received service data, and passes the acquired change time to out-of-area time counting section 408 as an maximum out-of-area time value.

Then, in step S1600, in-service-area determination section 405 acquires all timer values corresponding to information types of information included in the received service data (hereinafter referred to as “usable information types”) among information types subject to use. Specifically, in-service-area determination section 405 acquires timer values from a correspondence table held by information holding section 404 (see FIG. 9). Then in-service-area determination section 405 passes acquired usable information type timer values to in-area activation interval selection section 406.

In step S1700, in-area activation interval selection section 406 selects the smallest timer value from among the usable information type timer values, and sets the selected timer value in activation control section 401 via radio communication section 402.

Then, in step S1800, activation control section 401 determines whether or not processing termination has been directed by means of a user operation or the like. If processing termination has not been directed (S1800: NO), activation control section 401 returns to step S1100, whereas if processing termination has been directed (S1800: YES), activation control section 401 terminates the series of processing steps.

In step S1400, out-of-area determination section 407 determines that radio terminal apparatus 400 is out of service area from the fact that radio communication section 402 has not received service data, or that an out-of-service-area notification has been received from in-service-area determination section 405. Then out-of-area determination section 407 calls out-of-area time counting section 408, and issues an operation start directive to out-of-area time counting section 408. As a result, out-of-area time counting section 408 starts a time count if a time count has not been started, continues a time count if a time count has already been started.

Then, in step S1900, out-of-area time counting section 408 determines whether or not the count value has reached a set maximum out-of-area time value. If an maximum out-of-area time value has not been set, such as just after radio terminal apparatus 400 is powered on, for example, out-of-area time counting section 408 uses 0, for example, as an initial value of the maximum out-of-area time value. If the count value has not reached the set maximum out-of-area time value (S1900: NO), out-of-area time counting section 408 proceeds to step S1800. On the other hand, if the count value has reached the set maximum out-of-area time value (S1900: YES), out-of-area time counting section 408 calls out-of-area activation interval selection section 409, and proceeds to step S2000.

In step S2000, out-of-area activation interval selection section 409 acquires all timer values corresponding to information types subject to use from a correspondence table held by information holding section 404 (see FIG. 9).

Then, in step S2100, out-of-area activation interval selection section 409 selects the smallest timer value from among the acquired usable information type timer values, and sets the selected timer value in activation control section 401 via radio communication section 402.

By means of this kind of operation, when within service area, radio terminal apparatus 400 can activate its radio communication circuit at an interval of the smallest value among timer values corresponding to usable information types. Also, if an out-of-service-area state exceeds a change time notified by radio base station 200, radio terminal apparatus 400 can switch the radio communication circuit activation interval to an interval of the smallest value among timer values corresponding to information types subject to use.

Next, the operation of each apparatus section will be described.

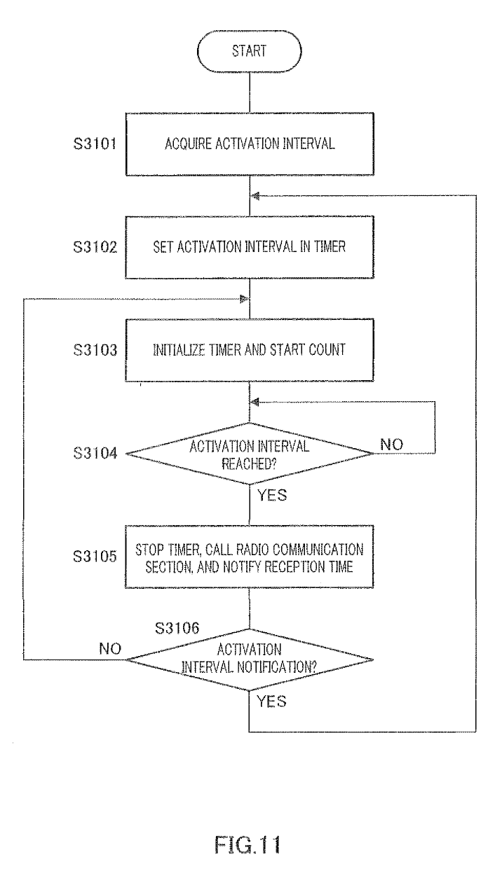

FIG. 11 is a flowchart showing the operation of activation control section 401.

First, in step S3101, activation control section 401 acquires an activation interval held internally in advance as an initial value.

Then, in step S3102, activation control section 401 sets the acquired activation interval in an internal timer.

Then, in step S3103, activation control section 401 initializes the timer and starts a count.

Then, in step S3104, activation control section 401 repeatedly determines whether or not the timer count has reached the set activation interval (S3104: NO) until the timer count reaches the set activation interval. When the timer count reaches the set activation interval (S3104: YES), activation control section 401 proceeds to step S3105.

In step S3105, activation control section 401 stops the timer, calls radio communication section 402, and notifies radio communication section 402 of an internally held reception time. By this means, radio communication section 402 starts reception processing, and notifies activation control section 401 of the activation interval as appropriate.

Then, in step S3106, activation control section 401 determines whether or not there is a new activation interval notification from radio communication section 402. If there is no new activation interval notification (S3106: NO), activation control section 401 returns to step S3103, whereas if there is a new activation interval notification (S3106: YES), activation control section 401 proceeds to step S3102.

Activation control section 401 may also return directly to step S3102 if notified of a new activation interval during an activation interval count in step S3104. Activation control section 401 may also improve the accuracy of an interval for controlling radio communication section 402 by subtracting the time required for the processing in steps S3102, S3105, and S3106 from the next activation interval count value. If directed to terminate processing by means of a user operation or the like, activation control section 401 terminates its operation.

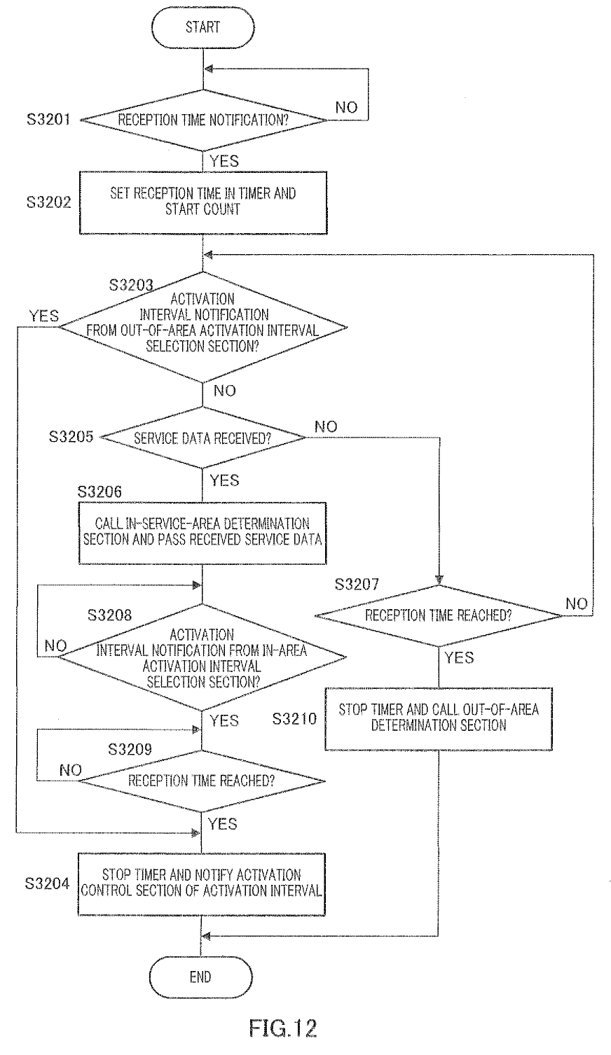

FIG. 12 is a flowchart showing the operation of radio communication section 402. Radio communication section 402 starts operating in response to a call from activation control section 401.

In step S3201, radio communication section 402 repeatedly determines whether or not there has been a reception time notification from activation control section 401 (S3201: NO) until determining that there has been a reception time notification. When there is a reception time notification (S3201: YES), radio communication section 402 proceeds to step S3202.

In step S3202, radio communication section 402 sets the notified reception time in an internal timer, and starts a count.

Then, in step S3203, radio communication section 402 determines whether or not there has been an activation interval notification from out-of-area activation interval selection section 409 (interrupt handling). If there has been an activation interval notification from out-of-area activation interval selection section 409 (S3203: YES), radio communication section 402 proceeds to step S3204. On the other hand, if there has been no activation interval notification from out-of-area activation interval selection section 409 (S3203: NO), radio communication section 402 proceeds to step S3205.

In step S3205, radio communication section 402 determines whether or not service data has been received from radio base station 200. If service data has been received (S3205: YES), radio communication section 402 proceeds to step S3206, whereas if service data has not been received (S3205: NO), radio communication section 402 proceeds to step S3207.

In step S3206, radio communication section 402 calls in-service-area determination section 405, and passes the received service data.

Then, in step S3208, radio communication section 402 repeatedly determines whether or not there has been an activation interval notification from in-area activation interval selection section 406 (interrupt handling) (S3208: NO) until determining that there has been an activation interval notification. When there is an activation interval notification (S3208: YES), radio communication section 402 proceeds to step S3209.

In step S3209, radio communication section 402 repeatedly determines whether or not the timer has reached the set reception time (S3209: NO) until determining that the timer has reached the reception time. When the timer reaches the set reception time (S3209: YES), radio communication section 402 proceeds to step S3204.

Then, in step S3204, radio communication section 402 stops the timer, and notifies activation control section 401 of the activation interval notified from out-of-area activation interval selection section 409 or in-area activation interval selection section 406. This activation interval is set in activation control section 401 (step S3102 in FIG. 11).

In step S3207, radio communication section 402 determines whether or not the timer has reached the set reception time. If the timer has not reached the set reception time (S3207: NO), radio communication section 402 returns to step S3203, whereas if the timer has reached the set reception time (S3207: YES), radio communication section 402 proceeds to step S3201.

In step S3210, radio communication section 402 stops the timer, and calls out-of-area determination section 407.

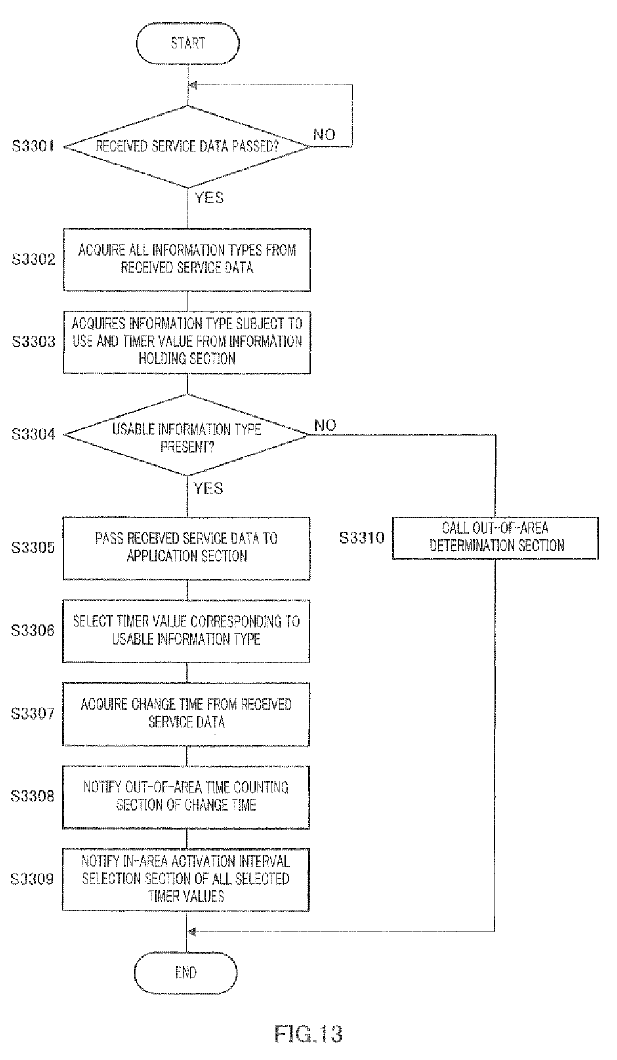

FIG. 13 is a flowchart showing the operation of in-service-area determination section 405. In-service-area determination section 405 starts operating in response to a call from radio communication section 402.

First, in step S3301, in-service-area determination section 405 repeatedly determines whether or not received service data has been passed from radio communication section 402 (S3301: NO) until determining that received service data has been passed. When received service data is passed (S3301: YES), in-service-area determination section 405 proceeds to step S3302.

In step S3302, in-service-area determination section 405 acquires all information types of information stored by received service data from received service data.

Then, in step S3303, in-service-area determination section 405 acquires information types subject to use, and a timer value of each information type subject to use, from information holding section 404.

Then, in step S3304, in-service-area determination section 405 determines whether or not a usable information type is present (whether radio terminal apparatus 400 is within service area or out of service area). That is to say, in-service-area determination section 405 determines whether or not an information type acquired from received service data is included in information types subject to use. If a usable information type is present (radio terminal apparatus 400 is within service area) (S3304: YES), in-service-area determination section 405 proceeds to step S3305. On the other hand, if a usable information type is not present (radio terminal apparatus 400 is out of service area) (S3304: NO), in-service-area determination section 405 proceeds to step S3310.

In step S3305, in-service-area determination section 405 passes received service data to application section 403.

Then, in step S3306, in-service-area determination section 405 selects a timer value corresponding to a usable information type from among the timer values acquired in step S3303.

Then, in step S3307, in-service-area determination section 405 acquires a change time stored in the received service data from the received service data.

Then, in step S3308, in-service-area determination section 405 notifies out-of-area time counting section 408 of the acquired change time.

Then, in step S3309, in-service-area determination section 405 calls in-area activation interval selection section 406, and notifies in-area activation interval selection section 406 of all selected timer values.

In step S3310, in-service-area determination section 405 calls out-of-area determination section 407, and starts its operation.

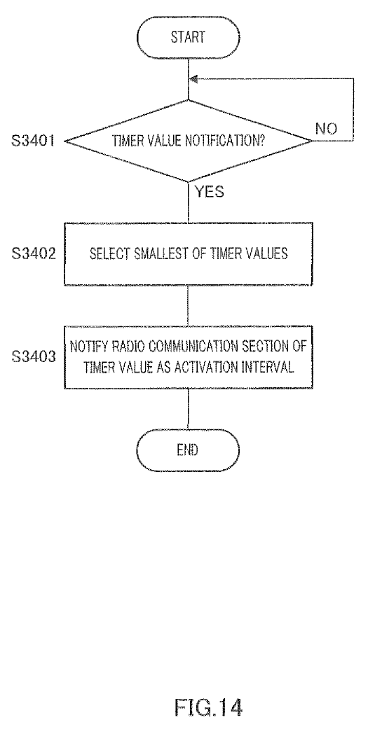

FIG. 14 is a flowchart showing the operation of in-area activation interval selection section 406. In-area activation interval selection section 406 starts operating in response to a call from in-service-area determination section 405.

in step S3401, in-area activation interval selection section 406 repeatedly determines whether or not a timer value notification has been received from in-service-area determination section 405 (S3401: NO) until a timer value notification is received. When a timer value notification is received from in-service-area determination section 405 (S3401: YES), in-area activation interval selection section 406 proceeds to step S3402.

In step S3402, in-area activation interval selection section 406 selects the smallest timer value from among notified timer values.

Then, in step S3403, in-area activation interval selection section 406 notifies radio communication section 402 of the selected timer value as an activation interval. This activation interval is set in activation control section 401 by radio communication section 402 (see FIG. 11 and FIG. 12).

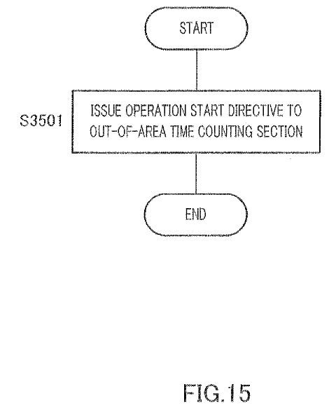

FIG. 15 is a flowchart showing the operation of out-of-area determination section 407. Out-of-area determination section 407 starts operating in response to a call from radio communication section 402 or in-service-area determination section 405.

In step S3501, out-of-area determination section 407 issues an operation start directive to out-of-area time counting section 408. Then out-of-area determination section 407 returns processing to radio communication section 402.

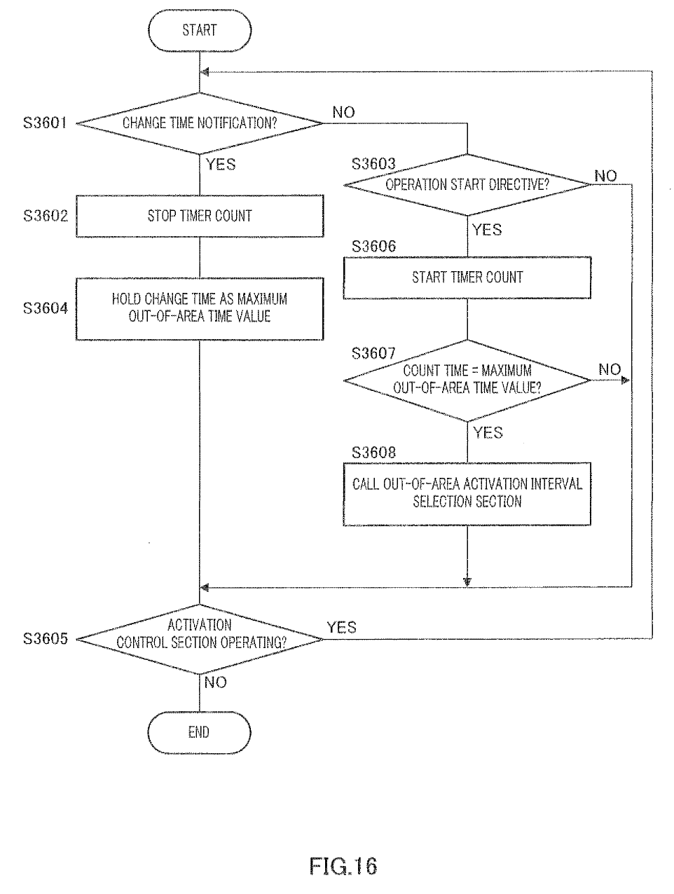

FIG. 16 is a flowchart showing the operation of out-of-area time counting section 408. Out-of-area time counting section 408 operates while at least activation control section 401 is operating.

First, in step S3601, out-of-area time counting section 408 determines whether or not there has been a change time notification from in-service-area determination section 405. A change time notification from in-service-area determination section 405 indicates that radio terminal apparatus 400 is within service area (see FIG. 13). If there is a change time notification (S3601: YES), out-of-area time counting section 408 proceeds to step S3602, whereas if there is no change time notification (S3601: NO), out-of-area time counting section 408 proceeds to step S3603.

In step S3602, if the internal timer is operating, out-of-area time counting section 408 stops it and returns it to its initial value.

Then, in step S3604, out-of-area time counting section 408 sets and holds the notified change time as an maximum out-of-area time value.

Then, in step S3605, out-of-area time counting section 408 determines whether or not activation control section 401 is operating. If activation control section 401 is operating (S3605: YES), out-of-area time counting section 408 returns to step S3601, whereas if activation control section 401 has stopped operating (S3605: NO), out-of-area time counting section 408 terminates its operation.

In step S3603, out-of-area time counting section 408 determines whether or not an operation start directive has been received from out-of-area determination section 407. If an operation start directive has not been received (S3603: NO), out-of-area time counting section 408 proceeds to step S3605. On the other hand, if an operation start directive has been received (S3603: YES), out-of-area time counting section 408 returns processing to out-of-area determination section 407, and proceeds to step S3606.

Then, in step S3606, if the internal timer is stopped, out-of-area time counting section 408 starts a count. On the other hand, if the internal timer is performing a count, out-of-area time counting section 408 continues the count.

Then, in step S3607, out-of-area time counting section 408 determines whether or not the internal timer's count time has reached the maximum out-of-area time value. If the internal timer's count time has not reached the maximum out-of-area time value (S3607: NO), out-of-area time counting section 408 proceeds to step S3605. On the other hand, if the internal timer's count time has reached the maximum out-of-area time value (S3607: YES), out-of-area time counting section 408 proceeds to step S3608.

In step S3608, out-of-area time counting section 408 calls out-of-area activation interval selection section 409, and proceeds to step S3605.

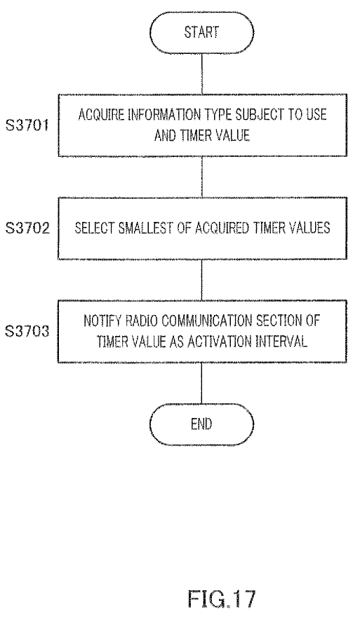

FIG. 17 is a flowchart showing the operation of out-of-area activation interval selection section 409. Out-of-area activation interval selection section 409 starts operating in response to a call from out-of-area time counting section 408.

First, in step S3701, out-of-area activation interval selection section 409 acquires information types subject to use, and a timer value of each information type subject to use, from information holding section 404.

Then, in step S3702, out-of-area activation interval selection section 409 selects the smallest timer value from among the acquired timer values.

Then, in step S3703, out-of-area activation interval selection section 409 notifies radio communication section 402 of the selected timer value as an activation interval (interrupt handling). This activation interval is set in activation control section 401 by radio communication section 402 (see FIG. 11 and FIG. 12).

By means of such operations by each apparatus section, radio terminal apparatus 400 can execute the operation shown in FIG. 10.

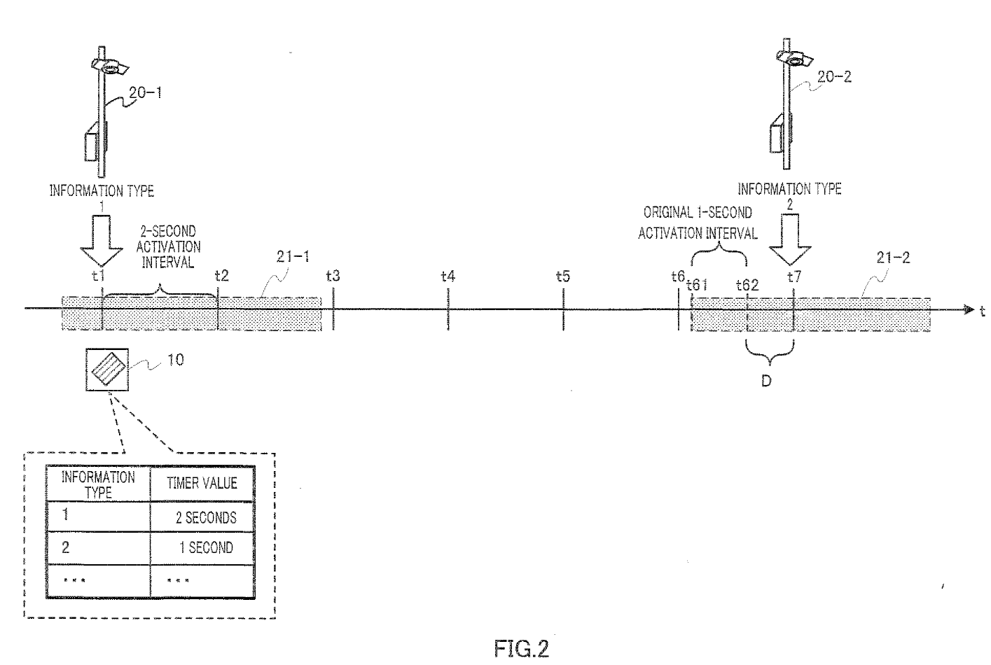

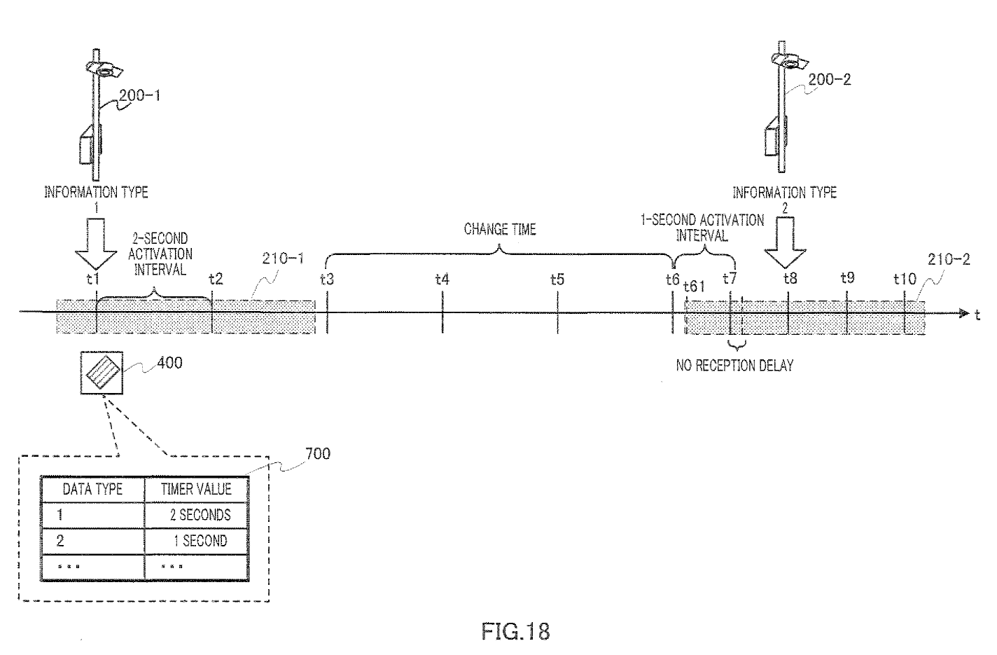

FIG. 18 is a schematic diagram for explaining the effect of radio terminal apparatus 400 of preventing a delay in information reception more dependably while suppressing power consumption, as compared with conventional technology, and corresponds to FIG. 2.

As shown in FIG. 18, a case is assumed in which radio terminal apparatus 400 travels from first communication area 210-1 of first radio base station 200-1 to second communication area 210-2 of second radio base station 200-2. Here, first radio base station 200-1 transmits only information of information type 1, and second radio base station 200-2 transmits only information of information type 2. It is assumed that radio terminal apparatus 400 was located in first communication area 210-1 from time t1 to time t2 due to traveling of user 300 or the like. It is further assumed that, due to traveling of user 300 or the like, radio terminal apparatus 400 travels out of first communication area 210-1 just before time t3, and enters second communication area 210-2 just after time t6.

In such a case, as illustrated in FIG. 2, with a conventional apparatus there is a possibility of a permitted range being greatly exceeded and information reception being delayed when second communication area 210-2 is entered.

However, as shown in FIG. 18, radio terminal apparatus 400 switches the activation interval to 1 second at time t6, for example, at which time a change time has elapsed since time t3 at which radio terminal apparatus 400 is determined to be out of service area. As explained above, a change time is a time period shorter than a minimum traveling time when user 300 travels from first communication area 210-1 to second communication area 210-2. Therefore, for example, radio terminal apparatus 400 enters second communication area 210-2 just after time t6 at which the activation interval is switched to 1 second.

Radio terminal apparatus 400 enters second communication area 210-2 and performs initial reception at time t7, at which time 1 second has elapsed since time t6. This is prior to the elapse of 1 second from time t6 at which radio terminal apparatus 400 entered second communication area 210-2. Therefore, there is no delay between the original reception time and the actual reception time.

As described above, when within service area, radio terminal apparatus 400 according to this embodiment sets the smallest value among usable information type timer values as a radio communication circuit activation interval. That is to say, when within service area, radio terminal apparatus 400 sets the smallest usable information notification interval value as a radio communication circuit activation interval. Also, when having become out of service area, radio terminal apparatus 400 sets the smallest value among timer values of information types subject to use as a radio communication circuit activation interval before traveling within the next service area. That is to say, when having become out of service area, radio terminal apparatus 400 sets the smallest notification interval value for information for which there is a possibility of use as a radio communication circuit activation interval.

By this means, radio terminal apparatus 400 can keep the frequency of radio communication circuit activation to a necessary minimum within service area, and more dependably prevent a delay in information reception when entering a new service area. That is to say, radio terminal apparatus 400 can achieve high power-saving capability while preventing a delay in information reception.

Also, with a conventional apparatus, when a traveling velocity is high and an activation interval is long, there is a possibility of passing through a small communication area 210, such as a service area in which a vehicle approach warning is given, during the reception time. That is to say, with a conventional apparatus, there is a possibility of not being able to acquire necessary information in a small communication area 210. Radio terminal apparatus 400 according to this embodiment can prevent such a situation since it switches to a short activation interval before entering a new communication area 210.

### Embodiment 2

Embodiment 2 of the present invention is an example in which a radio terminal apparatus calculates an appropriate maximum out-of-area time value, taking differences in the traveling velocities of individual radio terminal apparatuses into consideration.

A radio terminal apparatus according to this embodiment is an apparatus that performs communication with radio base station 200, in the same way as in Embodiment 1. However, in this embodiment, radio base station 200 stores an inter-area distance, instead of a change distance, in service data. An inter-area distance is the smallest value among distances from communication area 210 of transmitting radio base station 200 to other neighboring communication areas 210.

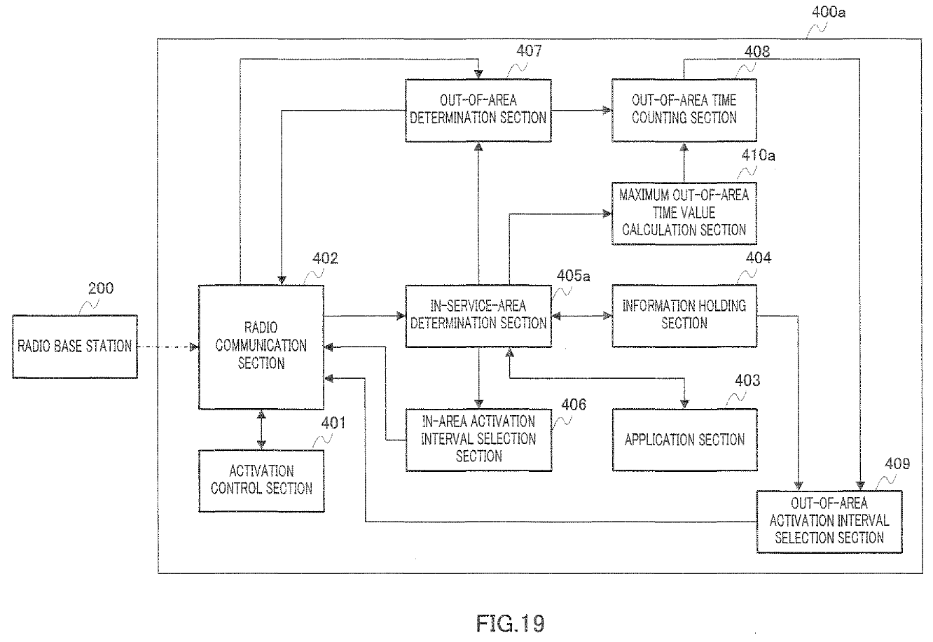

FIG. 19 is a block diagram showing the configuration of radio terminal apparatus 400a according to this embodiment, and corresponds to FIG. 8 of Embodiment 1. Parts in FIG. 19 identical to those in FIG. 8 are assigned the same reference codes as in FIG. 8, and descriptions thereof are omitted here.

As shown in FIG. 19, radio terminal apparatus 400a according to this embodiment has in-service-area determination section 405a instead of in-service-area determination section 405 of Embodiment 1, and also has maximum out-of-area time value calculation section 410a. Maximum out-of-area time value calculation section 410a is positioned between in-service-area determination section 405a and out-of-area time counting section 408.

When information of an information type subject to use is included in received service data, in-service-area determination section 405a extracts, not a change time, but an inter-area distance, from received service data. Then in-service-area determination section 405a passes the extracted inter-area distance to maximum out-of-area time value calculation section 410a.

Maximum out-of-area time value calculation section 410a calculates an maximum out-of-area time value based on a received inter-area distance and the traveling velocity of user 300. An maximum out-of-area time value is a minimum traveling time when user 300 travels from communication area 210-1 of transmitting radio base station 200 to another neighboring communication area 210.

A traveling velocity is set in maximum out-of-area time value calculation section 410a when radio terminal apparatus 400a is manufactured, for example. Maximum out-of-area time value calculation section 410a may also measure the traveling velocity of each radio terminal apparatus 400a using a sensor of some kind, and calculate a predicted traveling velocity based on the measured value. A sensor of some kind is, for example, a pedometer using a vibration sensor, a gyro sensor, a GPS (global positioning system) sensor, an acceleration sensor, or the like. Maximum out-of-area time value calculation section 410a may also acquire a traveling velocity by input of a traveling velocity value, or specification of items (age, sex, and so forth) associated in advance with different traveling velocities, from user 300.

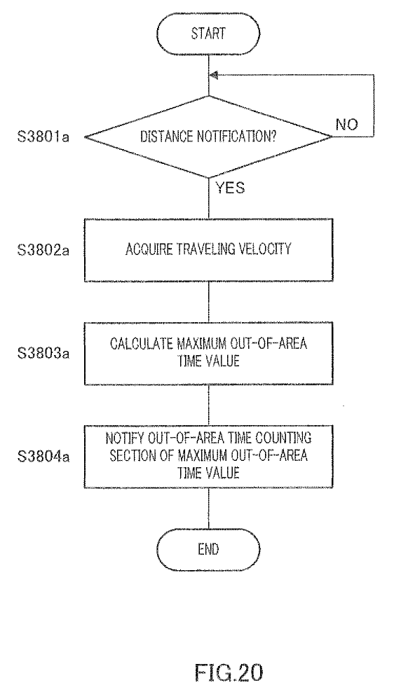

FIG. 20 is a flowchart showing the operation of maximum out-of-area time value calculation section 410a.

First, in step S3801a, maximum out-of-area time value calculation section 410a repeatedly determines whether or not an inter-area distance notification has been received from in-service-area determination section 405a (S3801a: NO) until determining that an inter-area distance notification has been received. When an inter-area distance notification is received (S3801a: YES), maximum out-of-area time value calculation section 410a proceeds to step S3802a.

In step S3802a, maximum out-of-area time value calculation section 410a acquires traveling velocity v of user 300 (that is, radio terminal apparatus 400a).

Then, in step S3803a, maximum out-of-area time value calculation section 410a calculates an maximum out-of-area time value by dividing notified inter-area distance L by traveling velocity v. However, it is desirable for maximum out-of-area time value calculation section 410a to correct the maximum out-of-area time value by deducting the maximum value of a set activation interval or timer value of an information type subject to use. This is because, as a time period from when radio terminal apparatus 400a leaves communication area 210 until radio terminal apparatus 400a first activates its radio communication circuit, a time close to the activation interval at that time is necessary at a maximum. This also applies to a change time in Embodiment 1.

For example, if inter-area distance L is 16 m, traveling velocity v is 2 m/sec, and the set activation interval is 2 seconds, the maximum out-of-area time value is calculated as 16/2−2=6 seconds.

Then, in step S3804a, maximum out-of-area time value calculation section 410a notifies out-of-area time counting section 408 of the calculated maximum out-of-area time value. As a result, an out-of-area activation interval selection section 409 call can be performed using an maximum out-of-area time value based on traveling velocity v for each radio terminal apparatus 400a in out-of-area time counting section 408.

Thus, radio terminal apparatus 400a according to this embodiment calculates an maximum out-of-area time value based on a traveling velocity of radio terminal apparatus 400a. By this means, radio terminal apparatus 400a can calculate a highly accurate maximum out-of-area time value even when the traveling velocity differs for each radio terminal apparatus 400a.

There is, for example, a great difference in the times required by a businessman and a mother with a child to cover the same distance. A delay in information reception can be prevented more dependably by uniform use of an maximum out-of-area time value appropriate to user 300 having a high traveling velocity, as in Embodiment 1. On the other hand, power consumption can be further suppressed by taking differences in the traveling velocities of radio terminal apparatuses 400a into consideration in calculating an appropriate maximum out-of-area time value, as in the case of radio terminal apparatus 400a according to this embodiment.

In the above-described embodiments, a radio terminal apparatus may stop activation of its radio communication circuit during a change time—that is, from determination of being out of service area until the count time reaches the maximum out-of-area time value (for example, t4 and t5 in FIG. 18). By this means, a radio terminal apparatus can achieve still greater power saving. If a radio terminal apparatus continues radio communication circuit activation without stopping, a delay in information reception can be suppressed even if the next communication area is entered earlier than expected. A situation in which the next communication area is entered earlier than expected may occur when a user runs, for instance.

After a user becomes out of service area, there may be a delay in next coming within service area. A situation in which there is a delay in next coming within service area may occur when a user changes his direction of traveling or stops traveling, for instance. Thus, a radio terminal apparatus may stop radio communication circuit activation if an in-service-area state is not entered after a fixed time has elapsed since the count time reached the maximum out-of-area time value, or if traveling is detected to have stopped out of service area. In these cases, provision may be made for a radio terminal apparatus to restart radio communication circuit activation upon detecting a user operation or the start of traveling of the radio terminal apparatus, for example.

A radio terminal apparatus has been assumed to acquire a change time or inter-area distance from a radio base station, but this is not a limitation. A radio terminal apparatus may, for example, store a change time, inter-area distance, or communication area location corresponding to each radio base station in advance, and acquire a corresponding change time or inter-area distance based on which communication area the radio terminal apparatus is currently located in.

A radio terminal apparatus may also use different change times or inter-area distances for the same communication area according to the direction of traveling of the radio terminal apparatus. In this case, for example, a radio base station performs association with each of a plurality of bearings, and stores change times or inter-area distances relating to other neighboring communication areas located on those bearings in service data. Then a radio terminal apparatus acquires a bearing of the direction of traveling of the radio-terminal apparatus by means of GPS or the like, and acquires a change time or inter-area distance corresponding to the acquired bearing.

The disclosure of Japanese Patent Application No. 2009-293252, filed on Dec. 24, 2009, including the specification, drawings and abstract, is incorporated herein by reference in its entirety.

### INDUSTRIAL APPLICABILITY

A radio terminal apparatus, radio communication system, and radio communication control method according to the present invention enable a delay in information reception to be more dependably prevented while suppressing power consumption, and are therefore suitable for use as a pedestrian safety support apparatus, senior citizen monitoring apparatus, advertising distribution apparatus, sightseeing information distribution apparatus, and so forth.

### REFERENCE SIGNS LIST

100 Radio communication system
200 Radio base station
210 Communication area
300 User
400, 400a Radio terminal apparatus
401 Activation control section
402 Radio communication section
403 Application section
404 information holding section
405, 405a In-service-area determination section
406 In-area activation interval selection section
407 Out-of-area determination section
408 Out-of-area time counting section
409 Out-of-area activation interval selection section
410a Maximum out-of-area time value calculation section

1. A radio terminal apparatus that performs radio communication with a radio base station, the radio terminal apparatus comprising:
an application section that acquires by means of the radio communication, and uses, service data that includes a plurality of items of information that should be acquired at different predetermined intervals;
a radio communication section that performs the radio communication;
an in-service-area determination section that determines, by means of the radio communication, which of the plurality of items of information is possible to be acquired, based on service data acquired by means of the radio communication; and
an activation control section that, when it is possible to acquire at least one of the plurality of items of information by means of the radio communication, controls activation/stopping of the radio communication section so as to perform the radio communication at the predetermined interval corresponding to that information, wherein the activation control section, when it is impossible to acquire any of the plurality of items of information by means of the radio communication, controls activation/stopping of the radio communication section so as to perform the radio communication at the shortest interval among the plurality of predetermined intervals.

2. The radio terminal apparatus according to claim 1, further comprising an information holding section that holds information types of the plurality of items of information, wherein the in-service-area determination section determines the information type of information transmitted by means of the radio communication, based on service data acquired by the radio communication section, and, when a determination result is included in the information type held in the information holding section, determines that it is possible to acquire information of that information type by means of the radio communication.

3. The radio terminal apparatus according to claim 1, further comprising:
an out-of-area activation interval selection section that, when a time when it is impossible to acquire any of the plurality of items of information by means of the radio communication reaches a predetermined length of time, causes the activation control section to switch to control of the shortest interval; and
an in-area activation interval selection section that, when it is possible to acquire at least one of the plurality of items of information by means of the radio communication, causes the activation control section to switch to control of the predetermined interval corresponding to that information.

4. The radio terminal apparatus according to claim 3, wherein:
the service data includes the predetermined length of time; and
the predetermined time is a time period shorter than a minimum traveling time when the radio terminal apparatus travels from a communication area of the radio base station to a communication area of another neighboring radio base station.

5. The radio terminal apparatus according to claim 3, wherein:
the service data includes a minimum traveling distance when the radio terminal apparatus travels from a communication area of the radio base station to a communication area of another neighboring radio base station; and
the activation interval selection section acquires the predetermined length of time based on a value obtained by dividing the minimum traveling distance obtained from the service data by a traveling velocity at a time of the traveling.

6. The radio terminal apparatus according to claim 1, wherein the in-area activation interval selection section, when it is possible to acquire at least two of the plurality of items of information, causes the activation control section to switch to control of the shortest interval among the predetermined intervals of those two or more items of information.

7. A radio communication system comprising:
a plurality of radio base stations that transmit respectively, by means of radio communication, service data that includes at least one of a plurality of items of information that should be acquired at different predetermined intervals, and that have mutually separated communication areas; and
a radio terminal apparatus that can travel between communication areas of the plurality of radio base stations and performs radio communication with the radio base station, wherein:
the radio base station transmits, by means of the service data, information relating to a minimum traveling time when traveling from a communication area of that radio base station to a communication area of a neighboring other the radio base station; and
the radio terminal apparatus has:
an application section that acquires by means of the radio communication, and uses, service data that includes the plurality of items of information;
a radio communication section that performs the radio communication; an in-service-area determination section that determines, by means of the radio communication, which of the plurality of items of information is possible to be acquired, based on service data acquired by means of the radio communication, and acquires the minimum traveling time;
an activation control section that, when it is possible to acquire at least one of the plurality of items of information by means of the radio communication, controls activation/stopping of the radio communication section so as to perform the radio communication at the predetermined interval corresponding to that information; and
an out-of-area activation interval selection section that, when a time when it is impossible to acquire any of the plurality of items of information by means of the radio communication reaches a predetermined length of time based on the minimum traveling time, causes the activation control section to switch to control of the shortest interval among the plurality of predetermined intervals.

8. A radio communication control method in a radio terminal apparatus provided with a radio communication section that performs radio communication with a radio base station and an application section that acquires by means of the radio communication, and uses, service data that includes a plurality of items of information that should be acquired at different predetermined intervals, the radio communication control method comprising:
a step of determining, by means of the radio communication, which of the plurality of items of information is possible to be acquired, based on service data acquired by means of the radio communication;
a step of, when a time when it is impossible to acquire any of the plurality of items of information by means of the radio communication reaches a predetermined length of time, switching control of activation/stopping of the radio communication section so as to perform the radio communication at the shortest interval among the plurality of predetermined intervals; and
a step of, when it is possible to acquire at least one of the plurality of items of information by means of the radio communication, switching control of activation/stopping of the radio communication section so as to perform the radio communication at the predetermined interval corresponding to that information.
